(19) United States
(12) Patent Application Publication
(10) Pub. No.: US 2002/0011815 A1
(43) Pub. Date: Jan. 31, 2002

(54) Motor control systems and methods employing force sensing resistors

(76) Inventors: Edward J. Gaffney, Pewaukee, WI (US); Randy J. Bleske, San Jose, CA (US)

Correspondence Address: Ryan Kromholtz & Manion SC, P O Box 26618, Milwaukee, WI, 53226-0618, US

(21) Appl. No.: 09/497,298

(22) Filed: Feb. 3, 2000

(51) Int. Cl. G05B 11/01

(52) U.S. Cl. 318/560

(57) ABSTRACT

Systems and methods use force sensing resistors to control the propulsion and/or speed of electrically powered vehicles in a straight forward, inexpensive, and ergonomic manner.

### FIELD OF THE INVENTION

In a general sense, the invention is directed to systems and methods for controlling electric motors to achieve propulsion or steering of vehicles.

### BACKGROUND OF THE INVENTION

Vehicles that employ electric motor driven wheels for propulsion and steering are well known, e.g., for use as golf carts, personal mobility scooters, or wheel chairs. The operator is allowed to either ride on the vehicle, or walk behind the vehicle, or both.

Vehicles of this type often encounter uneven terrain, which complicates the task of maintaining uniform speed and steering control. For example, when traveling downhill, the vehicles are prone to suddenly pick up speed due to pull of gravity. Sensors are often employed to monitor the actual speed of the wheel in comparison to the motor speed command, to detect an over speed condition and cause automatic braking to slow the vehicle. These sensors, and the microprocessor-based devices associated with them, add to the overall complexity and expense of the vehicle.

### SUMMARY OF THE INVENTION

The invention provides systems and methods that make it possible to control the propulsion and/or speed of electrically powered vehicles in a straight forward, inexpensive, and ergonomic manner.

One aspect of the invention provides a control system for an electric motor. The system comprises a controller operating to generate motor control signals in response to a command input. The system also comprises an interface including an actuator arranged for manipulation by an operator. The interface further includes a circuit coupled to the controller for generating the command input. The circuit includes at least one force sensing resistor coupled to the actuator, to vary the command input in response to manipulation of the actuator.

Another aspect of the invention provides a throttle interface for a vehicle. The throttle interface comprises a handle capable of being hand-held by an operator and an articulated mount, which is coupled to the handle for pivoting in response to force applied by the operator's hand. The throttle interface further includes a circuit for generating electrical command signals. The circuit includes a force sensing element, to which the articulated mount applies pressure in response to pivoting of the articulated mount. The force sensing element operates to vary the command signals in response to applied pressure.

In one embodiment, the force sensing element includes a force sensing resistor.

Another aspect of the invention provides a control system for an electric motor. The control system comprises an interface that includes an actuator arranged for manipulation by an operator. The interface also includes a circuit for generating command inputs. The circuit includes at least one force sensing element to which pressure is applied in response to manipulation of the actuator. The force sensing element operates to generate a first command signal in response to a first range of applied pressures and to generate a second command signal in response to a second range of applied pressures greater than the applied pressures in the first range. The control system also includes a controller that operates to generate a braking signal for the motor in response to the first command signal and to generate a drive signal for the motor in response to the second command signal.

In one embodiment, the force sensing element comprises a force sensing resistor.

In one embodiment, the actuator comprises a generally horizontal handle oriented to be hand-held by an operator when in a standing position.

In one embodiment, the braking signal conditions the motor for regenerative braking.

Features and advantages of the inventions are set forth in the following Description and Drawings, as well as in the appended Claims.

### BRIEF DESCRIPTION OF THE DRAWINGS

FIG. 1 is a schematic view of a motor control circuit for a vehicle that includes at least one force sensing resistor to generate a voltage input to a motor controller;

FIG. 2 is a schematic view of a voltage generating circuit utilizing a force sensing resistor, which can be used in association with the motor control circuit shown in FIG. 1;

FIG. 3 is a schematic view of a voltage generating circuit utilizing two force sensing resistors, which can be used in association with the motor control circuit shown in FIG. 1;

FIG. 4 is a perspective view of one possible embodiment of a throttle interface, implemented as a joystick-type controller, that can form a part of the voltage generating circuit shown in FIG. 3;

FIG. 5 is a perspective view of another possible embodiment of a throttle interface, implemented as a touch membrane key pad, that can form a part of the voltage generating circuit shown in FIG. 3;

FIG. 6 is a top view of another possible embodiment of a throttle interface, implemented as dual flex arm handle bar assembly, that can form a part of the voltage generating circuit shown in FIG. 3;

FIG. 7 is a perspective view of another possible embodiment of a throttle interface, implemented as rotating tiller grip, that can form a part of the voltage generating circuit shown in FIG. 3;

FIG. 8 is a schematic view of a motor control circuit for two motors, which includes several force sensing resistors to generate a voltage input to a motor controller and makes possible both propulsion and steering control for a multiple wheel vehicle;

FIG. 9 is a schematic view of a voltage generating circuit utilizing several force sensing resistor, which can be used in association with the motor control circuit shown in FIG. 8;

FIG. 10 is a schematic view of one possible embodiment of a throttle interface, implemented as a joystick-type controller, that can form a part of the voltage generating circuit shown in FIG. 9;

FIG. 11 is a perspective elevation view of a walk-behind, multiple wheel cart which incorporates a motor control circuit as shown in FIG. 8, and which includes a throttle interface for the motor control circuit realized as a horizontal handle intended to be grasped by the operator walking behind the cart;

FIG. 12 is an exploded perspective view of the handle embodiment of the throttle interface shown in FIG. 11;

FIG. 13 is a top assembled view of the handle embodiment of the throttle interface shown in FIG. 11;

FIG. 14 is a perspective elevation view of the walk-behind, multiple wheel cart shown in FIG. 11, with equipment that enable hands-off operation;

FIG. 15 is a schematic view of a brake pedal assembly that includes a force sensing resistor to enable an electric regenerative braking effect, as well as a pivot link that enables a mechanical braking effect; and

FIG. 16 is a schematic view of a dual function motor control pedal that incorporates a potentiometer.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION OF THE PREFERRED EMBODIMENTS

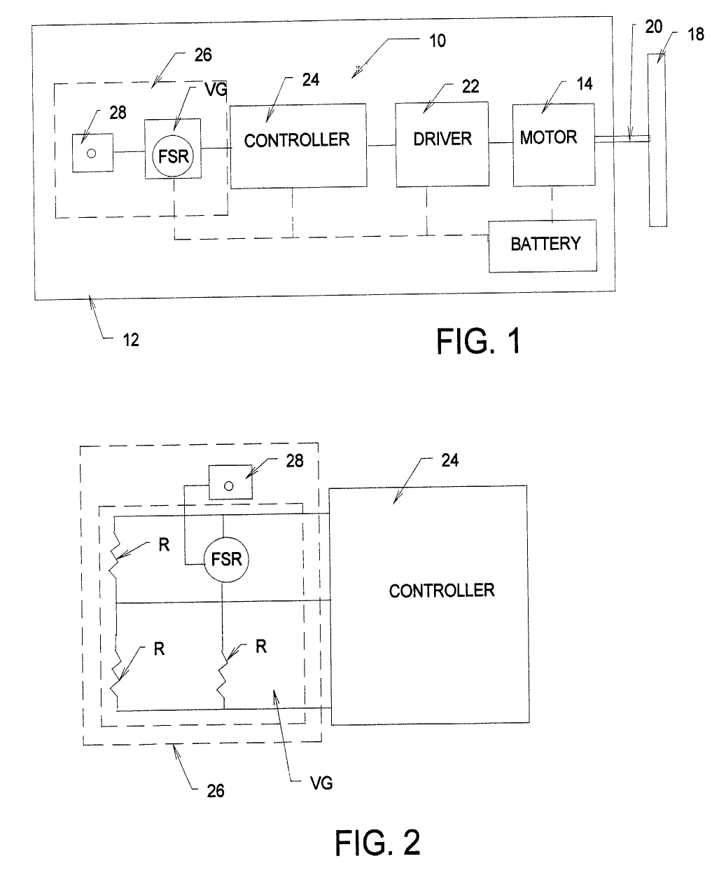

FIG. 1 schematically shows a control circuit 10 for a vehicle 12 or cart, which is driven by an electric motor 14. The motor 14 can comprise, e.g., a direct current, shunt type electric motor with independently excited armature and field windings. The motor 14 is typically powered by a rechargeable battery 16 carried by the vehicle 12.

The style and use of the vehicle 12 can vary. For example, the vehicle 12 can comprise a personal mobility scooter, or a golf cart of either a walk-behind or a riding category, or a wheel chair.

The vehicle 12 is supported on wheels 18 for movement on the ground. The motor 14 is conventionally coupled to the wheel 18 by a drive shaft 20. Typically, the vehicle 12 includes at least two motor-driven wheels 18. For purposes of illustration, FIG. 1 shows only one wheel 18.

The control circuit 10 includes a motor driver device 22. The device 22 can comprise, e.g., a conventional H-bridge/driver circuit. In this arrangement, the device 22 comprises a configuration of power switching devices (typically, transistors). The device 22 responds to prescribed control signals to apply voltage pulses to the armature and to vary the current in the field windings of the motor 14, which cause the motor 14 to rotate the wheel at the rate and in the direction desired by an operator.

The control circuit 10 also includes a microprocessor-based controller 24. The controller 24 supplies prescribed control signals to the motor driver device 22 according to rules programmed in the controller 24. The controller 24, in turn, responds to one or more analog voltage inputs, which, according to the programmed rules, cause the controller 24 to generate the control signals.

The control circuit 10 further includes a throttle interface 26. The throttle interface 26 generates the analog voltage inputs for the controller 24. The throttle interface 26 includes a manual actuator 28 that the operator manipulates in a predetermined manner. Manipulation of the actuator 28 generates the voltage inputs, which dictate desired speed and direction commands for the vehicle 12.

The throttle interface 26 includes a voltage generating circuit VG coupled to the battery 16, which generates analog voltage inputs for the controller 24. According to one aspect of the invention, the circuit VG includes at least one force sensing resistor FSR coupled to the actuator 28. The force sensing resistors can be commercially purchased, e.g., from Interlink Electronics.

The particular electrical configuration for the voltage generating circuit VG can vary. As represented in FIG. 2, the circuit VG comprises a typical parallel electrical circuit that includes fixed resistors R and the force sensing resistor FSR.

The resistor FSR possesses a resistance that varies in proportion to applied pressure. Variation in the resistance of the resistor FSR, in turn, varies the magnitude of the voltage inputs generated by the circuit VG. In the circuit VG shown in FIG. 2, a reduction in the resistance of the resistor FSR increases the magnitude of the voltage input, while an increase in the resistance of the resistor FSR decreases the magnitude of the voltage input.

The actuator 28 is linked to the resistor FSR to allow the operator to apply differential pressure to the resistor FSR. In the circuit VG shown in FIG. 2, incremental increases in pressure on the resistor FSR results in incremental decreases in resistance, and thereby generates incremental increases in voltage inputs by the circuit, and vice versa.

The rules programmed in the controller 24 prescribe the generation of different control signals to the motor driver device 22 in response to different analog voltage inputs. The rules programmed in the controller 24 can, or course, vary. For example, the rules can prescribe a control signal that causes the motor 14 to rotate the wheel 18 in a set direction in response to a threshold voltage input above analog zero, to thereby begin propelling the vehicle in a prescribed direction when a threshold pressure is applied to the resistor FSR by the actuator 28. The vehicle can be propelled forward or backward, depending upon the direction of wheel rotation prescribed by the control signal. In this arrangement, further incremental increases in the magnitude of the voltage input (by incrementally applying more pressure to the resistor FSR via the actuator 28) can result in the generation of control signals that incrementally increase the rate of rotation, to incrementally increase the vehicle speed.

The throttle interface 26 can take different forms. For example, the interface 26 can comprise a joystick-type controller, in which displacement of the joystick in a prescribed direction applies differential pressure on the resistor FSR. As another example, the interface 26 can comprise a membrane key pad, in which finger or thumb pressure applied to a membrane button applies differential pressure on the resistor FSR. Other embodiments for the throttle interface 26 will be described later.

Each motor driven wheel 18 of the vehicle 12 can be coupled to a control circuit 10 of the type shown in FIGS. 1 and 2. The direction and rate of rotation of each wheel 12 can thereby be independently controlled by a force sensing resistor FSR. Pressure can be selectively applied to each resistor FSR by separate actuators 28 or by a common actuator 28. Alternatively, a control circuit 10 of the type shown in FIGS. 1 and 2 can drive a single motor that is coupled by a differential to two wheels 18.

Furthermore, more than one force sensing resistor FSR can be used to control a single motor. The motor can be linked to a single wheel or linked to two wheels by a differential.

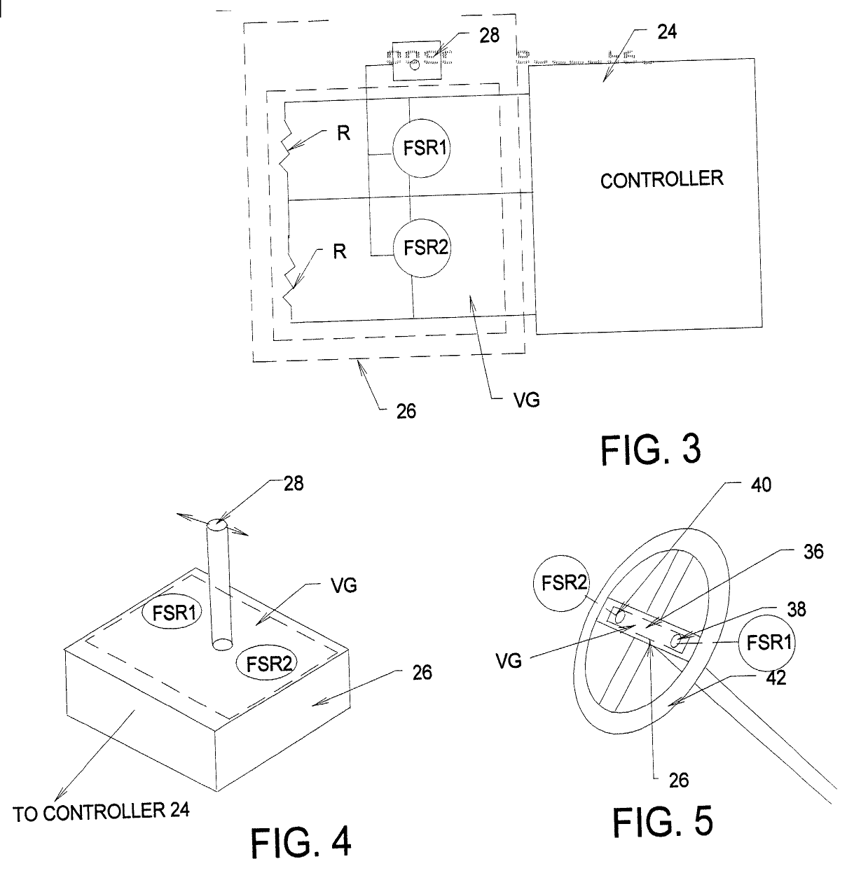

A representative electrical configuration for this embodiment is shown in FIG. 3. As there shown, the throttle interface 26 includes a voltage generating circuit VG for the controller 24 having two force sensing resistor FSR1 and FSR2. In this arrangement, the resistors FSR1 and FSR2 can be coupled to the same or different actuators 28 to affect differential pressure application.

In the electrical arrangement shown in FIG. 3, pressure applied to the resistor FSR1 increases the voltage input to the controller 24, while pressure applied to the resistor FSR2 decreases the voltage input to the controller 24. The rules programmed in the controller 24 prescribe the generation of different control signals to the motor driver device 22 in response to the magnitude of the analog voltage inputs. For example, pressure differentially applied to the resistor FSR1 (increasing the voltage input) can serve, through the controller 24, to drive the wheel 18 in a forward direction at different speeds, while pressure differentially applied to the resistor FSR2 (decreasing the voltage input) can serve, through the controller 24, to drive the wheel 18 in a reverse direction at different speeds. In this embodiment, a foot-actuated brake pedal can be provided, which can activate a mechanical braking action (through a mechanical link) or a regenerative braking action within the motor (through an electrical link), or both. For example, the brake pedal can be linked to a potentiometer, which varies the resistance of a voltage generating circuit linked to the controller, to vary the regenerative braking effect with increased depression of the brake pedal. Alternatively, as will be described in greater detail later, the brake pedal can be linked to a force sensing resistor to achieve a comparable variable regenerative braking effect.

As another example, pressure differentially applied to the resistor FSR1 can serve, through the controller 24, to drive the wheel 18 in a forward direction at different speeds, while pressure differentially applied to the resistor FSR2 can serve, through the controller 24, to apply a braking force to the wheel 18, either by means of an external mechanical brake 32 or by means of electrical regenerative braking generated within the motor 14 itself.

The throttle interface 26 shown in FIG. 3 can also take different forms. For example, the interface 26 can comprise a joystick-type controller 34 (see FIG. 4), in which displacement of the joystick in a forward direction applies differential pressure on the resistor FSR1 and displacement of the joystick in a rearward direction applies differential pressure upon the resistor FSR2. As another example, the interface 26 can comprise a membrane key pad 36 (see FIG. 5), in which finger or thumb pressure applied to a right hand membrane button 38 applies differential pressure on the resistor FSR1 and finger or thumb pressure applied to a left hand membrane button 40 applies differential pressure on the resistor FSR2. In FIG. 5, the key pad is shown as being carried by a steering wheel 42 for the vehicle.

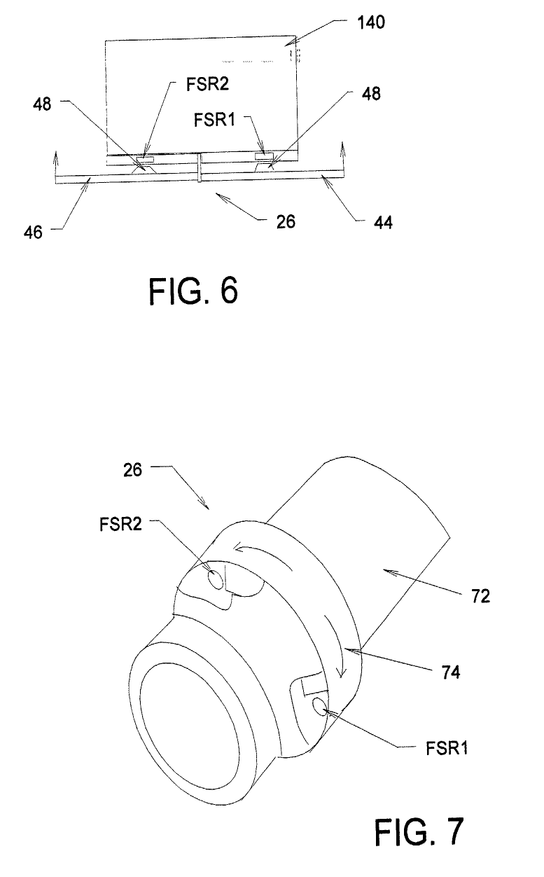

In another embodiment (see FIG. 6), the throttle interface 26 can include right and left horizontal flex arms 44 and 46, which are mounted on a console 140 behind which the operator sits or stands. In use, the operator grasps the ends of each flex arm 44 and 46, as one holds the handle bars of a bicycle.

Each flex arm 44 and 46 includes a plunger 48 aligned with a force sensing resistor FSR1 and FSR2. Each flex arm 44 and 46 is normally biased to hold the plunger 48 out of contact with the corresponding resistor FSR1 and FSR2. Flexure of a given arm 44 and 26 moves the respective plunger 48 into a pressure applying relationship with the corresponding resistor FSR1 or FSR2.

As shown in FIG. 7, the throttle interface 26 can include a tiller 72 with a grip 74 that twists about the free end of the tiller 74. As FIG. 7 shows, the tiller 72 carries a first force sensing resistor FSR1 to which pressure is applied when the tiller grip 74 is twisted in one direction. The tiller 72 also carries a second force sensing resistor FSR2 to which pressure is applied when the tiller grip 74 is twisted in the opposite direction. Twisting the tiller grip 74 can therefore impart, e.g., forward and rearward movement. Alternatively, twisting the tiller grip 74 in one direction can impart accelerated forward movement while twisting the tiller grip 74 in the opposite direction can impart regenerative or mechanical braking. In this arrangement, the tiller 72 itself can be mechanically linked to a steering mechanism, so that transverse movement of the tiller 72 steers the vehicle.

It should be appreciated that two function control as above described can also be implemented using a potentiometer, without employing force sensing resistors. As shown in FIG. 16, a centrally pivoted control pedal 132 is linked to a potentiometer 134. The potentiometer 132 forms a part of voltage generating circuit 138 for a controller 136. Force directed on the front of the control pedal 132 (arrow A in FIG. 16) seesaws the pedal 132 in a first direction, which operates the potentiometer 134 to increase the voltage input to the controller 24. Force directed upon the rear of the control pedal 132 (arrow B in FIG. 16) see-saws the pedal 132 in a second direction, which operates the potentiometer 134 to decrease the voltage input to the controller 24.

As before explained, the rules programmed in the controller 24 can serve to drive the wheel 18 in different ways depending upon the magnitude of the voltage inputs. For example, the controller 24 can drive the wheel 18 in a forward direction at different speeds in response to increased voltage inputs (with the pedal 132 swung in direction of arrow A), as well as to drive the wheel 18 in a reverse direction at different speeds (or to apply a regenerative braking effect) in response to decreased voltage inputs (with the pedal 132 swung in the direction of arrow B).

The use of force sensing resistors in a voltage generating circuit VG coupled in association with a preprogrammed motor controller also makes possible control of both propulsion and steering in multiple wheel vehicles.

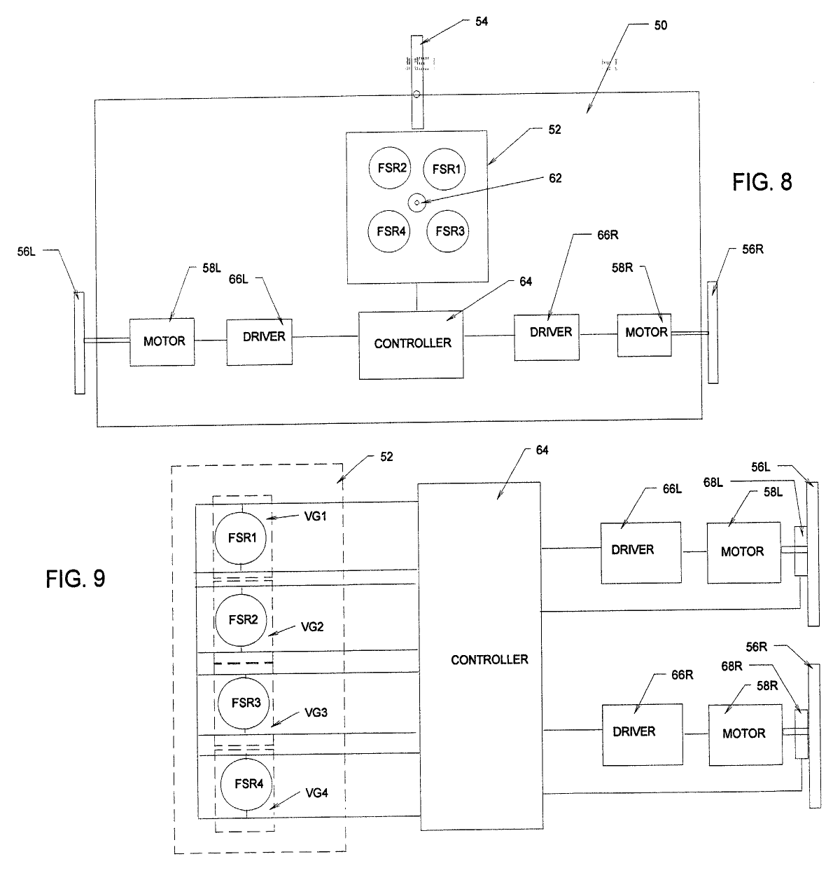

For example, FIG. 8 shows a three-wheel vehicle 50 including an embodiment of a throttle interface 52 that also embodies features of the invention. The vehicle 50 comprises a swivel-mounted front wheel 54, which is idle and not power driven. The vehicle 50 also includes left and right rear wheels 56L and 56R, which are each independently powered by a direct current motor 58L and 58R. The motors 58L and 58R are coupled to a motor control circuit 60 (see FIG. 9).

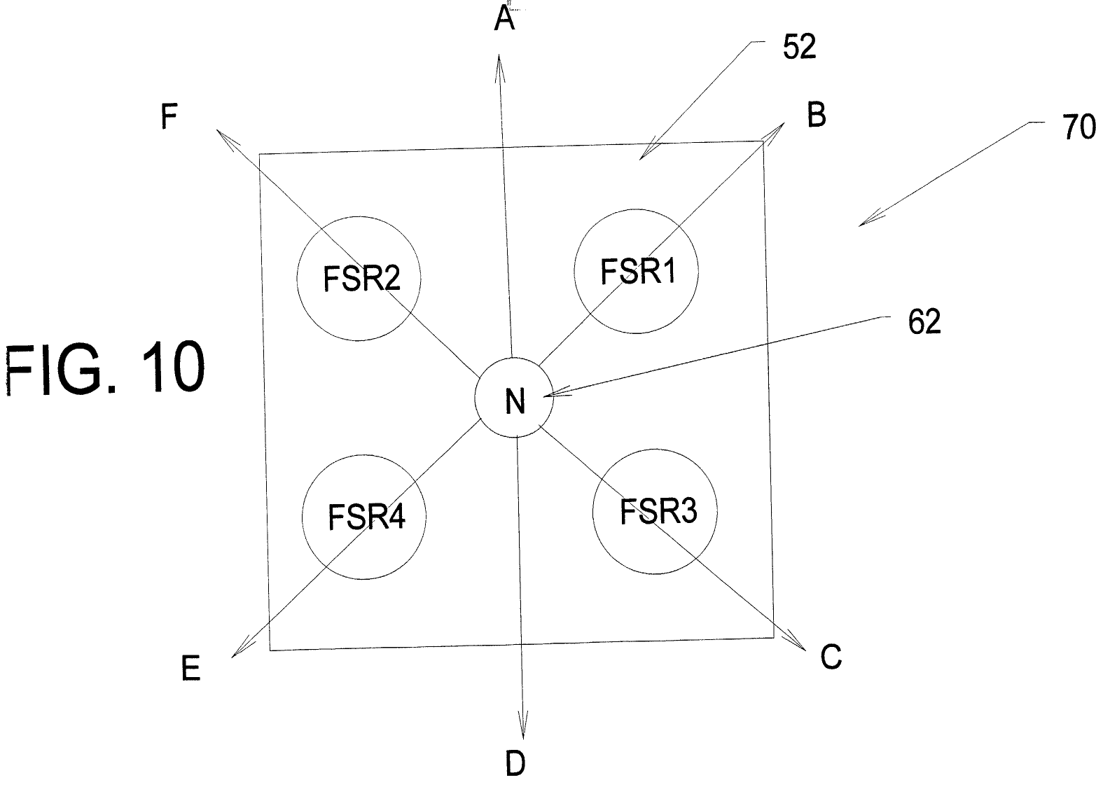

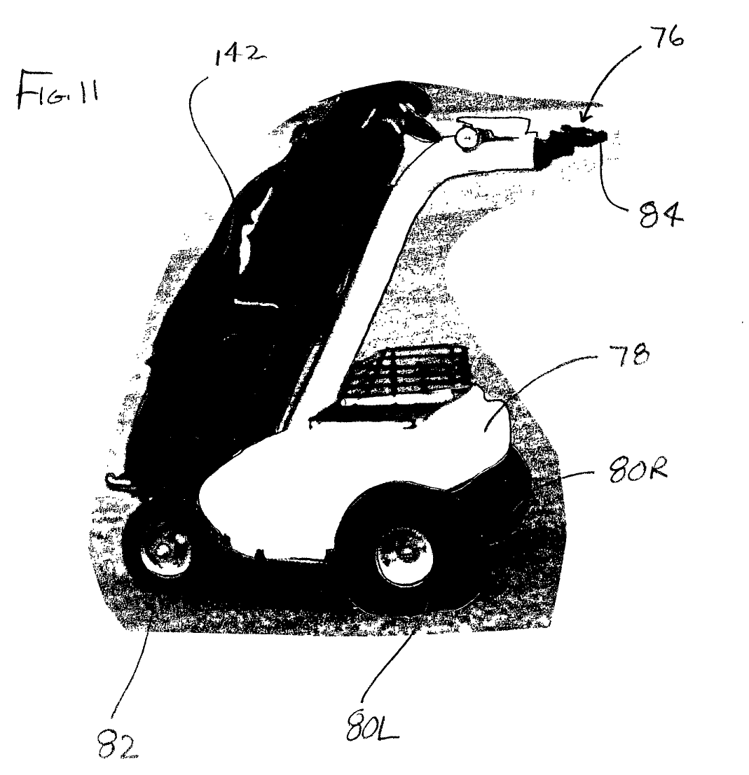

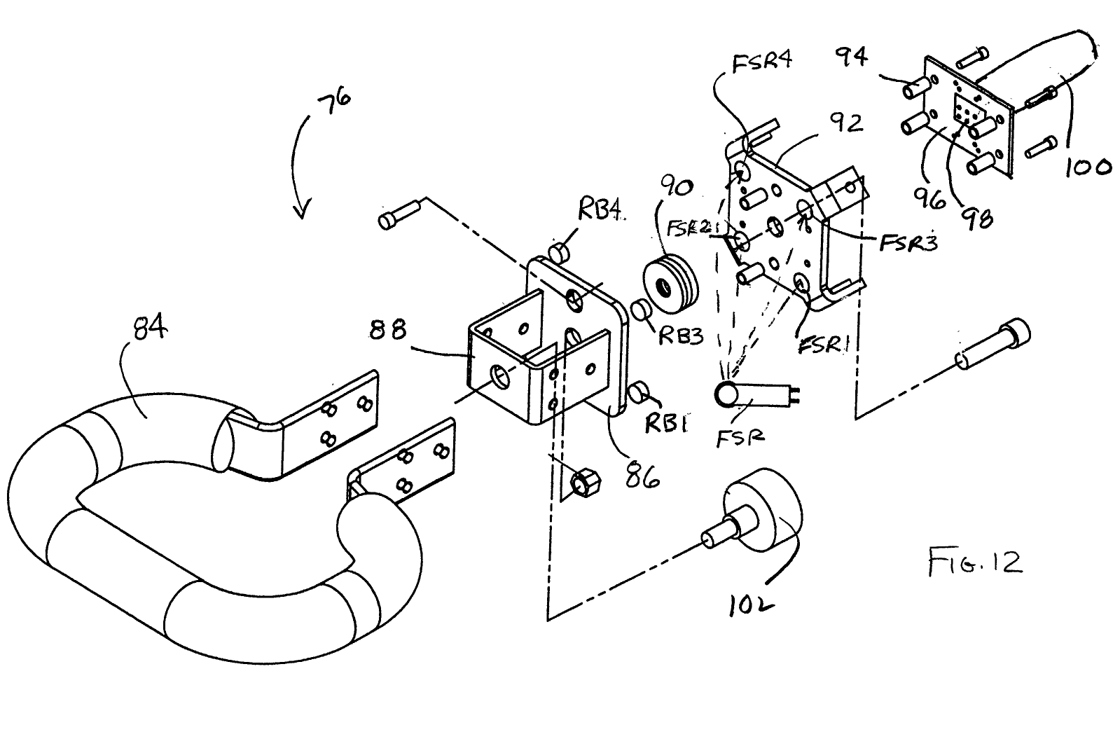

As FIG. 9 shows, the throttle interface 52 includes four voltage generating circuits VG1 to VG4, each with a force sensing resistor FSR1 to FSR4. As shown in FIG. 10, the resistors FSR1 to FSR4 are actuated by a single articulated actuator 62, although multiple actuators can be employed. The pre-programmed rules of the controller 64 independently respond to analog voltage inputs from the circuits VG1 and VG3 to generate command signals to the motor driver 66R of the right rear wheel 56R. The pre-programmed rules of the controller 64 independently respond to analog voltage inputs from the circuits VG2 and VG4 to generate command signals to the motor driver 66L of the left rear wheel 56L.

As FIG. 10 shows, the actuator 62 is biased toward a neutral position N. In this position, force is not applied to any one of the resistors FSR1 to FSR4, and the voltage inputs of each circuit VG1 to VG4 reflect zero analog voltage. As a result, no motor command signals are generated, and the vehicle 50 is at rest. Mechanical brakes 68L and 68R can be provided, which the controller 64 enables to lock the rear wheels 56L and 56R when the actuator 62 occupies the neutral position N.

As FIG. 10 also shows, the actuator 62 is articulated and can be moved by the operator from the neutral position N in a range of direct forward and rearward directions A and D, oblique forward directions B and F, and oblique rearward directions C and E. Movement of the actuator 62 applies differential forces to the resistors FSR1, FSR2, FSR3, and FSR4, thereby creating an array of differential voltage inputs to the microprocessor-based controller 64. The controller 64 provides according to its preprogrammed rules different command signals to the motor drivers 66L and 66R based upon the different voltage inputs of the circuits VG1 to VG4. In this way, the motors 58L and 58R of the right and left rear wheels 56L and 56R can be individually controlled to achieve forward and rearward travel as well as steering.

In this arrangement, the application by the operator of direct forward force to the actuator 62 in the direction A, applies equal pressure upon FSR1 and FSR2 and no pressure upon FSR3 and FSR4. Equal voltage inputs based upon FSR1 and FSR2 and zero voltage inputs based upon FSR3 and FSR4 result. In response, the microprocessor-based controller 64 disengages the mechanical brakes 68L and 68R (if present) and also conditions the motor drivers 66L and 66R to rotate both rear wheels 56L and 56R in a forward direction and at essentially the same rate of rotation. As a result, the vehicle 50 moves forward and in an essentially straight path. As the distance in direction A increases from the neutral position N, progressively greater pressure is applied equally upon FSR1 and FSR2. As the equal voltage inputs based upon FSR1 and FSR2 increase, the rate of equal forward rotation of the wheels 56L and 56R increases, thereby increasing the forward speed of the vehicle 50.

Movement of the actuator 62 by the operator in the forward oblique direction B applies greater pressure upon FSR1 than FSR2, but still continues to apply no pressure upon FSR3 and FSR4. The microprocessor-based controller 64 receives a voltage input based upon FSR1 that is greater in magnitude than the voltage input based upon FSR2. In response to the different voltage inputs, the microprocessor-based controller 64 conditions the motor drivers 66L and 66R to rotate the right rear wheel 56R in a forward direction at a rate of rotation greater than the forward rate of the left rear wheel 56L. As a result, the vehicle 50 moves forward and turns to the left. As the distance in oblique direction B increases from the neutral position N, progressively greater differentially pressure is applied upon FSR1, increasing the left turn rate and reducing the diameter of turning circle.

Movement of the actuator 62 by the operator in the forward oblique direction F applies greater pressure upon FSR2 than FSR1. The microprocessor-based controller 64 receives a voltage input based upon FSR2 that is greater in magnitude than the voltage input based upon FSR1. In response to the different voltage inputs, the microprocessor-based controller 64 conditions the motor drivers 66L and 66R to rotate the left rear wheel 56L in a forward direction at a rate of rotation greater than the forward rate of the right rear wheel 56R. As a result, the vehicle 50 moves forward and turns to the right. As the distance in oblique direction F increases from the neutral position N, progressively greater differentially pressure is applied upon FSR2, increasing the right turn rate and reducing the diameter of turning circle.

Also in this arrangement, applying direct rearward force by the operator to the actuator 62 in the direction D, applies equal pressure upon FSR3 and FSR4 and no pressure upon FSR1 and FSR2. Zero voltage inputs based upon FSR1 and FSR2 and equal voltage inputs based upon FSR3 and FSR4 result. In response, the microprocessor-based controller 64 disengages the mechanical brakes 68L and 68R (if present) and also conditions the motor drivers 66L and 66R to rotate the rear wheels 56L and 56R in a rearward direction and at essentially the same rate of rotation. As a result, the vehicle 50 moves backward and in an essentially straight path. As the distance in direction D increases from the neutral position N, progressively greater pressure is applied equally upon FSR3 and FSR4. The rate of equal rearward rotation of the wheels 56L and 56R increases, thereby increasing the rearward speed of the vehicle.

Movement of the actuator 62 by the operator in the rearward oblique direction C applies greater pressure upon FSR3 than FSR4. The microprocessor-based controller 64 receives a voltage input based upon FSR3 that is greater in magnitude than the voltage input based upon FSR4. In response to the different voltage inputs, the microprocessor-based controller 64 conditions the motor drivers 66L and 66R to rotate the right rear wheel 56R in a rearward direction at a rate of rotation greater than the rearward rate of the left rear wheel 56L. As a result, the vehicle 50 moves backward and swings to the right. As the distance in oblique direction C increases from the neutral position N, progressively greater differentially pressure is applied upon FSR3, increasing the backward right turn rate and reducing the diameter of turning circle.

Movement of the actuator 62 by the operator in the rearward oblique direction E applies greater pressure upon FSR4 than FSR3. The microprocessor-based controller 64 receives a voltage input based upon FSR4 that is greater in magnitude than the voltage input based upon FSR3. In response to the different voltage inputs, the microprocessor-based controller 64 conditions the motor drivers 66L and 66R to rotate the left rear wheel in a rearward direction at a rate of rotation greater than the rearward rate of the right rear wheel. As a result, the vehicle 50 moves backward and swings to the left. As the distance in oblique direction E increases from the neutral position N, progressively greater differentially pressure is applied upon FSR4, increasing the backward left turn rate and reducing the diameter of turning circle.

Alternatively, a single direct current drive motor can be coupled by a differential gear arrangement to the two rear wheels. In this arrangement, an additional direct current motor is provided for steering. A drive motor arrangement that can be use is shown, e.g., in Gaffney U.S. Pat. No. 5,853,346, which is incorporated herein by reference.

As shown in FIG. 10, the throttle interface 52 can be implemented as an articulated joystick-like controller 70 with four resistors FSR1 to FSR4. It should be appreciated that a joystick-like controller 70 can include more than four force sensing resistors or less than four force sensing resistors, depending upon the control functions required. For example, a joystick-like controller 70 having only fore and aft force sensing resistors can be used to provide forward or rearward travel capabilities. In this arrangement, mechanical linkages can be provided to affect steering, or alternatively, a second joystick-like controller can be provided with right and left force sensing resistors that provide selective regenerative braking action to the motors to affect steering.

FIG. 11 shows a throttle interface 76 employing force sensing resistors that achieve ergonomic control of both propulsion and steering in a multiple wheel vehicle. The vehicle takes the form of a three wheel, walk-behind cart 78 for carrying golf bags 142 and the like. The cart 78 includes motor driven left and right rear wheels 80L and 80R and a single, swivelled front idle wheel 82.

The throttle interface 76 includes a horizontally extending handle 84, which is presented at generally chest to shoulder height to the operator. The handle 84 is intended to be grasped by the operator while walking behind the cart 78. The operator manipulates the handle 84 to provide both speed and direction commands to the motor driven left and right rear wheels 80L and 80R.

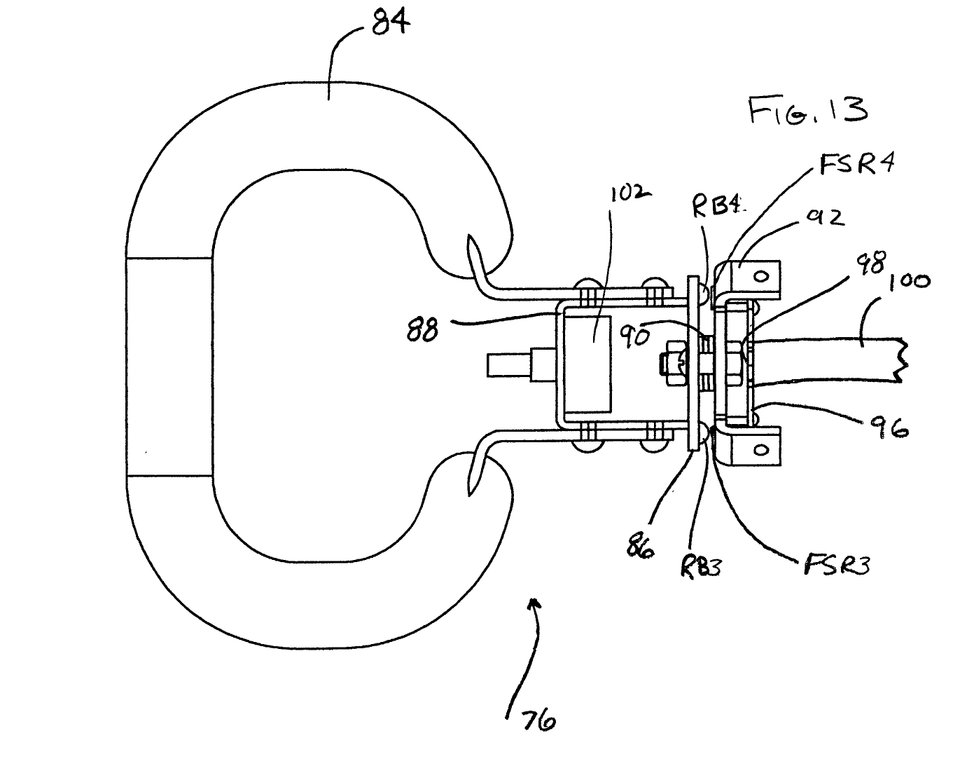

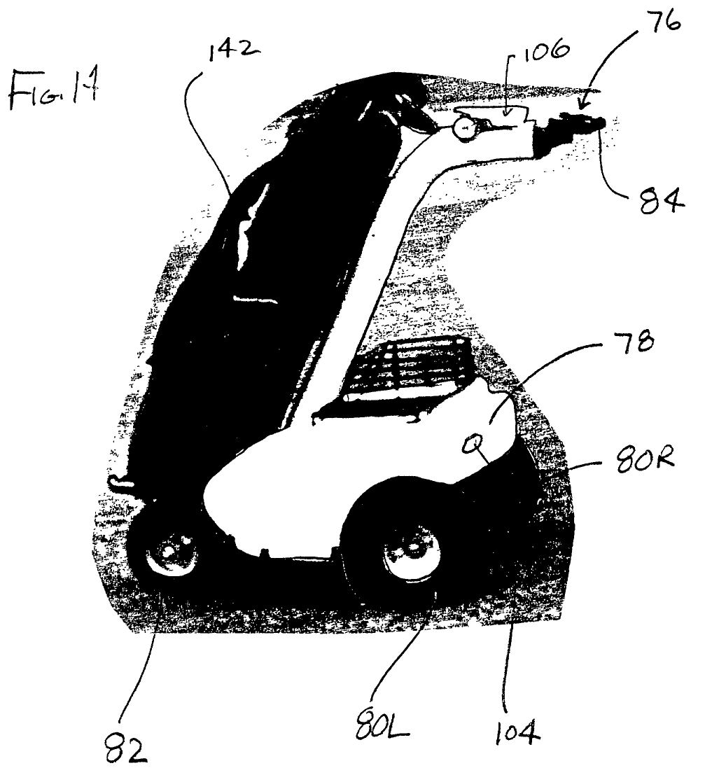

As FIGS. 12 and 13 show, the throttle interface 76 includes a gimbal plate 86 that is coupled by a bracket 88 to the handle 84. The gimbal plate 86 is coupled by a central spring washer assembly 90 to a sensor plate 92. The sensor plate 92 is mounted upon spacers 94 to a support board 96.

The gimbal plate 86 rocks on the spring washer assembly 90 relative to the sensor plate 92 in response to forces applied by the operator to the handle 84. Upward and downward forces applied to the handle 84 rocks the top and bottom portions of the gimbal plate 86 toward and away from the facing top and bottom portions of the sensor plate 92. Leftward and rightward forces applied to the handle 84 rocks the left and right side portions of the gimbal plate 86 toward the facing left and right side portions of the sensor plate 92.

Four force sensing resistors FSR1 to FSR4 are carried at the four corners of the sensor plate 92. Looking forward in the direction of the handle 84, the resistor FSR1 is located at the bottom right hand corner of the sensor plate 92; the resistor FSR2 is located at the bottom left hand corner of the sensor plate 92; the resistor FSR3 is located at the top right hand corner of the sensor plate 92; and the resistor FSR4 is located at the top left hand corner of the sensor plate 92.

The force sensing resistors FSR1 to FSR4 are each electrically coupled to an electrical connector 98 on the support board 96. An electrical cable 100 attaches to the connector 98, to electrically couple each of the FSR1 to FSR4 to a voltage generating circuit VG1 to VG4 of the type shown in FIG. 9.

Four corresponding rubber bumpers RB1 to RB4 are carried at the four corners of the gimbal plate 86. As the gimbal plate 86 rocks relative to the sensor plate 92, one or more of the bumpers RB1 to RB4 apply pressure to the corresponding force sensing resistors FSR1 to FSR4. The orientation and magnitude of the pressure on the resistors FSR1 to FSR4 depends upon the direction and magnitude of the force applied to the handle 84. In this way, selective manipulation of the handle by the operator changes the resistance of one or more of the resistors FSR1 to FSR4 and the magnitude of analog voltages generated by the corresponding circuit.

The spring washer assembly 90 orients the gimbal plate 86 in a neutral position N in the absence of force applied by the operator to the handle 84. In the neutral position, no contact between the bumpers RB1 to RB4 and any resistor FSR1 to FSR4 occurs. This condition corresponds to neutral position N in FIG. 10, as already described. In this position, the voltage inputs of each circuit VG1 to VG4 to the microprocessor-based controller 64 are essentially zero. As a result, the cart 78 is at rest. As before described, magnetic brakes coupled to the microprocessor-based controller 64 can be provided, which lock the rear wheels 80L and 80R in the absence of force to the handle 84.

When the operator applies a direct downward pressure to the handle 84, the rubber bumpers RB1 and RB2 apply equal pressure, respectively, to resistors FSR1 and FSR2, while the rubber bumpers RB3 and RB4 apply no pressure, respectively, to resistors FSR3 and FSR4 . This condition corresponds to the direction A condition shown in FIG. 10. Equal voltage inputs from VG1 and VG2 and zero voltage inputs from VG3 and VG4 cause the microprocessor-based controller 64 to disengage the mechanical brakes (if present) and also condition the motor drivers 66L and 66R to rotate both rear wheels in a forward direction and at essentially the same rate of rotation. As a result, the cart 78 advances forward in front of the operator in an essentially straight path.

Walking behind the cart 78, downward force applied by the operator to the handle 84 will fluctuate naturally in relation to the relative speed relationship between the cart 78 and the operator. If the cart 78 travels slower than the operator, the cart 78 will draw nearer to the operator, and downward pressure on the handle 84 will naturally increase, to speed up the cart 78. If the cart 78 travels faster than the operator, the cart 78 will draw away from the operator, and downward pressure on the handle 84 will naturally decrease, to slow down the cart 78. The downward deflection of the handle 84 will tend to stabilize at an equilibrium position, in which the forward speed of the cart 78 matches the walking speed of the operator, during both uphill and downhill travel.

In this arrangement, complicated and expensive motor RPM sensors, wheel speed sensors, and the like are not required to electronically provide feedback information that, when processed by the controller 64, keep the cart 78 and operator together. The pressure of the handle 84 in the hand of the operator provides tactile feedback, which the operator's brain processes to dictate natural voluntary muscle responses, which keep the operator and the cart 78 moving in synchrony.

To further enhance the ergonomic interaction between the operator and the cart 78, particularly when traveling downhill, the controller 64 can be programmed to include a regenerative braking regime when downward pressure applied to the handle 84 generates analog voltage inputs that lay at or below an established minimum threshold value. The regenerative braking regime automatically slows cart speed when relatively low downward pressure is being applied to the handle 84, as would occur, e.g., as cart speed increases due to gravity on a downhill slope. The regenerative braking regime counteracts the increase in speed due to gravity in such a situation, thereby preventing an over speed condition during travel upon downhill terrain, so that the cart will not tend to pull abruptly away from the operator. In this arrangement, controller 64 terminates the regenerative braking regime when downward pressure above the minimum threshold value is applied to the handle 84, and instead commands the cart 78 to accelerate with increasing downward handle pressure. In this way, the cart 78 keeps pace with the operator when traveling on generally flat or uphill terrain.

While still applying a downward pressure, the operator can apply either a right or left oblique force to the handle 84. The rubber bumpers RB1 and RB2 no longer apply equal pressure, respectively, to resistors FSR1 and FSR2, and resistor toward which the oblique force is applied (FSR1 for a right oblique force, and FSR2 for a left oblique force) will experience a greater differential force. The oblique right condition corresponds to the direction B condition shown in FIG. 10, and the oblique left condition corresponds to the direction F condition in FIG. 10.

When resistor FSR1 experiences a greater differential force than resistor FSR2, the voltage of VG1 will be greater than the voltage of VG2. As a result, the right rear wheel rotates in a forward direction at a rate of rotation greater than the forward rate of the left rear wheel. The cart 78, moving forward, turns to the left. As the force differential increases, the left turn rate increases and the diameter of turning circle is reduced.

Likewise, when resistor FSR2 experiences a greater differential force than resistor FSR1, the voltage of VG2 will be greater than the voltage of VG1. As a result, the left rear wheel rotates in a forward direction at a rate of rotation greater than the forward rate of the right rear wheel. The cart 78, moving forward, turns to the right. As the force differential increases, the right turn rate increases and the diameter of turning circle is reduced.

From behind the cart 78, the application of a direct upward lifting force to the handle 84 causes the rubber bumpers RB3 and RB4 to apply equal pressure, respectively, to resistors FSR3 and FSR4, while the rubber bumpers RB1 and RB2 apply no pressure, respectively, to resistors FSR1 and FSR2 . This condition corresponds to the direction D condition shown in FIG. 10. Equal voltage inputs from VG3 and VG4 and zero voltage inputs from VG1 and VG2 cause the microprocessor-based controller 64 to disengage the mechanical brakes (if present) and also condition the motor drivers to rotate both rear wheels in a rearward direction and at essentially the same rate of rotation. As a result, the cart 78 backs up in an essentially straight path.

While still applying an upward lifting pressure, the operator can apply either a right or left oblique force to the handle 84. The rubber bumpers RB3 and RB4 no longer apply equal pressure, respectively, to resistors FSR3 and FSR4, and resistor toward which the oblique force is applied (FSR3 for a right oblique force, and FSR4 for a left oblique force) will experience a greater differential force. The oblique right condition corresponds to the direction C condition shown in FIG. 10, and the oblique left condition corresponds to the direction E condition in FIG. 10.

When resistor FSR3 experiences a greater differential force than resistor FSR4, the voltage of VG3 will be greater than the voltage of VG4. As a result, the right rear wheel rotates in a rearward direction at a rate of rotation greater than the rearward rate of the left rear wheel. The cart 78, moving backward, swings to the right. As the force differential increases, the right swing rate increases and the diameter of turning circle is reduced.

Likewise, when resistor FSR4 experiences a greater differential force than resistor FSR3, the voltage of VG4 will be greater than the voltage of VG3. As a result, the left rear wheel rotates in a rearward direction at a rate of rotation greater than the rearward rate of the right rear wheel. The cart 78, moving backward, swings to the left. As the force differential increases, the left swing rate increases and the diameter of turning circle is reduced.

When pressure applied to the handle 84 is released, the controller 64 can also be programmed to enter a ramp-down regime. During the ramp-down regime, the controller 64 commands a period of regenerative braking, which can be either linear or progressive over time. If mechanical brakes are present, the controller 64 can also activate the mechanical brakes at the end of the ramp-down regime.

In the illustrated embodiment (see FIGS. 12 and 13), the gimbal plate 86 holds a potentiometer 102. The potentiometer 102 is electrically coupled to the resistors FSR1 to FSR4. Adjustment of the potentiometer 102 adjusts the rate at which resistance of the resistors FSR1 to FSR4 changes in proportion to the magnitude of force applied. The potentiometer thereby allows the individual operator to electrically adjust the response sensitivity of the handle 84. For example, for an individual who walks at a brisk pace and wants the cart 78 to travel accordingly, a high sensitivity, leading to a relatively rapid speed-to-pressure response, is indicated. Likewise, for an individual who walks at a more leisurely pace, a lower sensitivity, leading to a relatively slow speed-to-pressure response, is indicated.

As shown in FIG. 14, the throttle interface 76 can includes a momentary switch 106. Upon pushing downward upon the handle 84 to create forward movement of the cart 78 at a desired speed, the operator can activate the momentary switch 106 and let go of the handle 84. The momentary switch maintains the forward progress of the cart 78 at the current speed, allowing the operator to walk behind the cart 78 in a hands-free condition.

The hands-free operation continues until the operator touches the handle 84 to deactivate the momentary switch 106.

In this arrangement, the throttle interface 76 can also include an ultrasonic sensor 104. The sensor 104 monitors the presence of the operator within a field of view behind the cart 78. The sensor 104 permits hands-free operation to continue (prior to touch-deactivation of the momentary switch 106) as long as the operator lays inside the view range of the ultrasonic sensor 104.

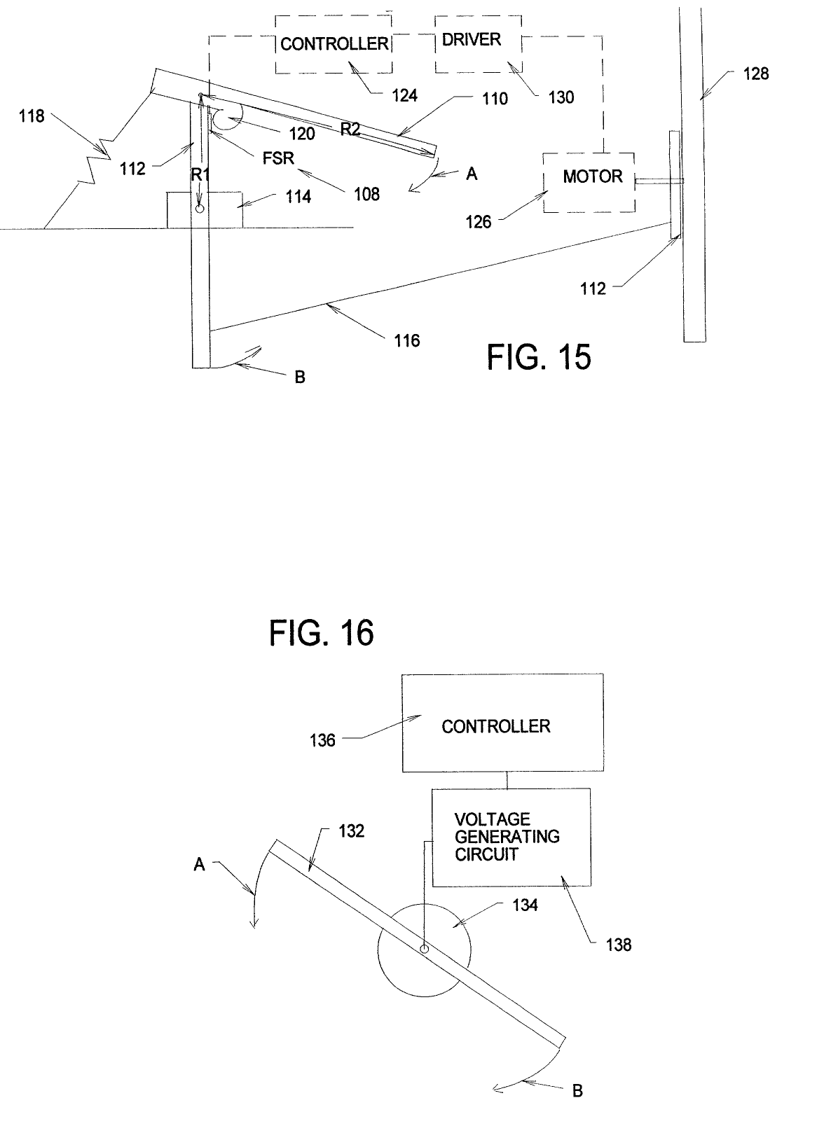

Force sensing resistors FSR's can also be used in other ways to control a vehicle. For example, as shown in FIG. 15, a brake pedal assembly 108 includes a foot pedal 110, which pivotally mounted on one end of a pivot link 112. The opposite end of the pivot link 112 is coupled to a cable 116, which is also coupled to a mechanical brake assembly 122 of the vehicle.

The pivot link 112 is itself pivotally mounted on a bracket 114 between its two ends. The swing radius R1 of the foot pedal 110 is larger than the swing radius R2 of the pivot link bar 112. Force applied to the foot pedal 110 will therefore first swing the foot pedal 110 about its axis before the pivot link 112 swings about its axis.

The pivot link 112 carries a force sensing resistor FSR. The resistor FSR is part of a voltage generating circuit that supplies voltage inputs to a microprocessor-based controller 124 for an electric direct current motor 126, which drives a wheel 128.

A spring 118 normally biases the foot pedal 110 toward a rest position, as shown in FIG. 15. The foot pedal 110 includes a plunger 120. The plunger 120 is normally spaced from contact with the resistor FSR when the foot pedal 110 is in its rest position.

Force applied to the foot pedal 110 will first cause pivotal swinging of the brake pedal 108 about its axis, as arrow A in FIG. 15 shows. This causes the plunger 120 to apply pressure to the resistor FSR. Pressure to the resistor FSR changes its resistance and, in turn, varies the voltage input to the controller 124. The controller 124 commands a motor driver 130 to create a regenerative braking effect in the motor 126 in proportion to the amount of pressure applied by the foot pedal 110 to the resistor FSR.

Continued force applied to the foot pedal 110 will maximize the regenerative braking effect and eventually cause the pivot link 112 to swing about its axis, as shown by arrow B in FIG. 15. The swinging of the pivot link 112 operates the cable 116 to activate the mechanical brake assembly 122.

The brake pedal assembly 108 shown in FIG. 15 therefore achieves electrical regenerative braking through a force sensing resistor FSR and mechanical braking through the pivot link 112.

It should be appreciated that the various throttle interfaces and motor control schemes are not limited in their implementation to the use of force sensing resistors. Other electrical, mechanical, or electromechanical devices capable of providing variable electrical output in response to operator interaction, e.g., switches, strain gauges, Hall generators, and equivalents thereof, can be used in the place of the force sensing resistors.

Various features of the invention are set forth in the following claims.

We claim:

1. A control system for an electric motor comprising
a controller operating to generate motor control signals in response to a command input, and
an interface including an actuator arranged for manipulation by an operator, and a circuit coupled to the controller for generating the command input including at least one force sensing resistor coupled to the actuator to vary the command input in response to manipulation of the actuator.

2. A control system according to claim 1
wherein the actuator includes a joystick element that, in response to lateral displacement, applies pressure to the force sensing resistor.

3. A control system according to claim 1
wherein the actuator includes a membrane button that, in response to manual pressure, applies pressure to the force sensing resistor.

4. A control system according to claim 1
wherein the actuator includes a flexible element that, in response to flexure, applies pressure to the force sensing resistor.

5. A control system according to claim 1
wherein the actuator includes a rotating element that, in response to rotation, applies pressure to the force sensing resistor.

6. A control system according to claim 1
wherein the actuator includes a pedal element that, in response to displacement, applies pressure to the force sensing resistor.

7. A control system according to claim 1
wherein the actuator includes an articulated handle element that, in response to articulation of the handle element, applies pressure to the force sensing resistor.

8. A control system according to claim 1
wherein the circuit includes first and second force sensing resistors, and
wherein the actuator is coupled to the first and second force sensing resistors.

9. A control system according to claim 1
wherein the circuit includes first and second force sensing resistors,
wherein the actuator is coupled to the first force sensing resistor, and
wherein the interface includes a second actuator coupled to the second force sensing resistor.

10. A control system according to claim 1
wherein the controller is programmable.

11. A control system according to claim 1
wherein one of the motor command signals comprises a motor direction command.

12. A control system according to claim 1
wherein one of the motor command signals comprises a motor speed command.

13. A control system according to claim 1
wherein one of the motor command signals comprises a motor braking command.

14. A control system according to claim 1
wherein the circuit includes a first force sensing resistor to generate a first command input in response to manipulation of the actuator, and a second force sensing resistor to generate a second command input, different than the first command input, in response to manipulation of the actuator.

15. A control system according to claim 1
wherein the controller generates a first motor control signal in response to the first command input and a second motor control signal, different than the first motor control signal, in response to the second command input.

16. A control system according to claim 15
wherein one of the first and second motor command signals comprises a motor direction command.

17. A control system according to claim 15
wherein one of the first and second motor command signals comprises a motor speed command.

18. A control system according to claim 15
wherein one of the first and second motor command signals comprises a motor braking command.

19. A throttle interface for a vehicle comprising
a handle capable of being held by an operator's hand,
an articulated mount coupled to the handle for pivoting in response to force applied by the operator's hand, and
a circuit for generating electrical command signals including a force sensing element to which the articulated mount applies pressure in response to pivoting of the articulated mount, the force sensing element operating to vary the command signals in response to applied pressure.

20. A throttle interface according to claim 19
wherein the force sensing element includes a force sensing resistor.

21. A throttle interface according to claim 19
wherein the circuit includes a device to prescribe a rate of variation of the command signal in response to applied pressure.

22. A throttle interface according to claim 19
wherein the circuit includes a momentary switch.

23. A throttle interface according to claim 19
wherein the circuit includes first and second force sensing elements,
wherein the articulated mount applies pressure to the first force sensing element in response to pivoting of the articulated mount in a first direction, and
wherein the articulated mount applies pressure to the second force sensing element in response to pivoting of the articulated mount is a second direction, different than the first direction.

24. A throttle interface according to claim 23
wherein the circuit generates a first command signal in response to applied pressure to the first sensing element and a second command signal, different than the first command signal, in response to applied pressure to the second sensing element.

25. A throttle interface according to claim 19 wherein the circuit includes an electric motor that operates in response to the command signals.

26. A throttle interface according to claim 25
wherein one of the command signals comprises a motor direction command.

27. A throttle interface according to claim 25
wherein one of the command signals comprises a motor speed command.

28. A throttle interface according to claim 25
wherein one of the command signals comprises a motor braking command.

29. A throttle interface according to claim 19
wherein the handle is generally horizontally oriented.

30. A control system for an electric motor comprising
an interface including an actuator arranged for manipulation by an operator, and a circuit for generating command inputs including at least one force sensing element to which pressure is applied in response to manipulation of the actuator, the force sensing element operating to generate a first command signal in response to a first range of applied pressures and to generate a second command signal in response to a second range of applied pressures greater than the applied pressures in the first range, and
a controller coupled to the circuit and operating to generate a braking signal for the motor in response to the first command signal and to generate a drive signal for the motor in response to the second command signal.

31. A control system according to claim 30
wherein the force sensing element comprises a force sensing resistor.

32. A control system according to claim 30
wherein the actuator comprises a generally horizontal handle oriented to be hand-held by an operator when in a standing position.

33. A control system according to claim 30
wherein the braking signal affects regenerative braking of the motor.
